(19) United States
(12) Patent Application Publication
(10) Pub. No.: US 2018/0167235 A1
(43) Pub. Date: Jun. 14, 2018

(54) ADAPTIVE CHANNEL ESTIMATION

(71) Applicant: QUALCOMM Incorporated, San Diego, CA (US)

(72) Inventors: Zixia Hu, San Jose, CA (US); Youhan Kim, San Jose, CA (US); Kai Shi, San Jose, CA (US)

(21) Appl. No.: 15/820,050

(22) Filed: Nov. 21, 2017

Related U.S. Application Data
(60) Provisional application No. 62/433,647, filed on Dec. 13, 2016.

(51) Int. Cl. H04L 25/02; H04L 27/01

(52) U.S. Cl. CPC H04L 25/0202; H04B 1/16; H04L 27/01

(57) ABSTRACT

A receiver includes power estimation circuitry configured to estimate a first power associated with a first field of a packet and a second power associated with a second field of the packet. The receiver additionally includes channel estimation circuitry configured to determine a second channel estimation of a channel associated with communication of the packet. The second channel estimation is determined based on the first power, the second power, and a first channel estimation of the channel.

### I. CROSS REFERENCE TO RELATED APPLICATIONS

The present application claims priority from U.S. Provisional Patent Application No. 62/433,647 entitled “ADAPTIVE CHANNEL ESTIMATION,” filed Dec. 13, 2016, which is incorporated herein by reference in its entirety.

### II. FIELD

The present disclosure is generally related to channel estimation.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

These devices may include a receiver that receives a signal that is transmitted over a channel. The received signal may include amplitude and/or phase distortions. The devices may equalize the signal using a channel estimation. The channel estimation may be inaccurate. For example, the devices may determine a channel estimation based on a training sequence in a power boosted portion of the signal (e.g., based on a preamble of the signal). The channel estimation based on the power boosted portion of the signal may be used to equalize a portion of the signal that is not power boosted (e.g., a data portion of the signal). Using a channel estimation that is determined based on the power boosted portion of the signal to equalize a portion of the signal that is not power boosted may insufficiently or incorrectly equalize the portion of the signal that is not power boosted, resulting in bit errors during demapping/demodulation of the equalized signals.

### IV. SUMMARY

In a particular aspect, a receiver includes power difference estimation circuitry configured to estimate a power difference between a first power associated with a first field of a packet and a second power associated with a second field of the packet. The receiver additionally includes channel estimation circuitry configured to determine a second channel estimation of a channel associated with propagation of the packet based on the power difference.

In a particular aspect, a method includes receiving a packet via a wireless signal. The method further includes determining a first power associated with a first field of a packet. The method further includes determining a second power associated with a second field of the packet. The method further includes determining a power difference between the first power and the second power. The method further includes determining a second channel estimation associated with the wireless signal based on the power difference. The method further includes decoding at least a portion of the packet based on the second channel estimation.

In a particular aspect, an apparatus includes means for receiving a packet via a wireless signal. The apparatus includes means for estimating a first power associated with a first field of the packet and a second power associated with a second field of the packet. The apparatus additionally includes means for determining a second channel estimation of a channel associated with communication of the packet. The second channel estimation is determined based on a first channel estimation of the channel, the first power, and the second power.

In a particular aspect, a receiver includes power estimation circuitry configured to estimate a first power of a first field of a packet and a second power of a second field of the packet. The receiver additionally includes channel estimation circuitry configured to determine a second channel estimation of a channel associated with communication of the packet. The second channel estimation is determined based on a first channel estimation of the channel, the first power, and the second power.

In a particular aspect, a method includes receiving a packet via a wireless signal. The method additionally includes determining a first power associated with a first field of a packet. The method additionally includes determining a second power associated with a second field of the packet. The method additionally includes determining a second channel estimation associated with communication of the wireless signal. The second channel estimation is based on the first power, the second power, and a first channel estimation associated with communication of the wireless signal. The method additionally includes decoding at least a portion of the packet based on the second channel estimation.

In a particular aspect, a non-transitory, computer readable medium stores instructions that, when executed by the processor, cause the processor to receive a packet via a wireless signal. The instructions cause the processor to determine a first power associated with a first field of the packet. The instructions cause the processor to determine a second power associated with a second field of the packet. The instructions cause the processor to determine a second channel estimation associated with communication of the wireless signal. The second channel estimation is determined based on the first power, the second power, and a first channel estimation associated with communication of the wireless signal. The instructions further cause the processor to decode at least a portion of the packet based on the second channel estimation.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 illustrates a block diagram of a system that includes a receiver configured to determine a second channel estimation based on a power difference between, or a ratio of, a power of a first field of a packet and a power of a second field of the packet;

FIG. 2 is a flow chart of a particular illustrative example of a method of determining a second channel estimation based on a first channel estimation, a first power associated with a first field of a packet, and a second power associated with a second field of the packet;

FIG. 3 is a flow chart of a particular illustrative example of a method of determining a second channel estimation based on a power difference between a power of a first field of a packet and a power of a second field of the packet; and

FIG. 4 is a block diagram of mobile device including channel estimation circuitry to determine a second channel estimation based on a first channel estimation, a first power associated with a first field of a packet, and a second power associated with a second field of the packet.

### VI. DETAILED DESCRIPTION

Particular implementations of the present disclosure are described below with reference to the drawings. In the description, common features are designated by common reference numbers throughout the drawings. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

As used herein, various terminology is for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.”

Institute of Electrical and Electronics Engineers (IEEE) 802.11ax, also known as the “High Efficiency WLAN,” is an in-progress industry standard that is expected to use a version (e.g., orthogonal frequency division multiple access) of orthogonal frequency division multiplexing (OFDM), including in indoor and outdoor scenarios that are impacted by interfering signal sources, dense heterogeneous networks, and heavily loaded access points. In some examples, the described techniques may be used in an IEEE 802.11ax compliant wireless network. Alternatively or additionally, the described techniques may be used in a wireless network other than an IEEE 802.11ax compliant wireless network. For example, the described techniques may be used in a wireless network that complies with IEEE 802.11a, IEEE 802.11g, IEEE 802.11n, or IEEE 802.11ac.

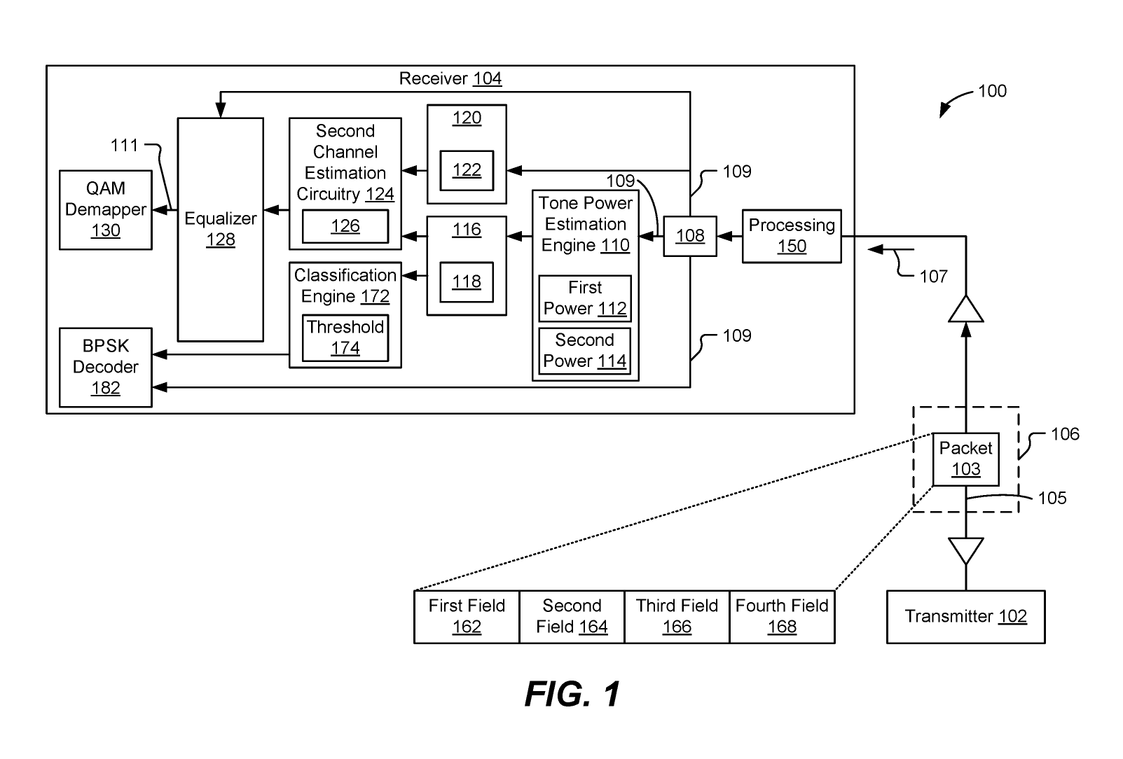

FIG. 1 illustrates a system 100 (e.g., a communication system) including a transmitter 102 and a receiver 104. The transmitter 102 is configured to transmit a signal 105 including a packet 103. The packet 103 may be one of multiple different types of packets. To illustrate, the packet 103 may be a single-user (SU) packet, a multi-user (MU) packet, a trigger-based packet, or another type of packet. In some examples, the transmitter 102 is configured to transmit the signal 105 according to an OFDM scheme, such as IEEE 802.11ax. In these examples, the signal 105 (e.g., the packet 103) is transmitted to the receiver 104 over multiple sub-carriers of a channel 106. For example, the transmitter 102 may receive input data including the packet 103, may buffer the packet 103 into blocks, and may divide the packet 103 into bit streams (e.g., m bit streams). These bit streams are mapped to complex constellation points X_{i,k}, i=0 . . . m−1 at a k^{th} block, and modulated (e.g., using an IFT) into the time domain.

In the example illustrated in FIG. 1, the packet 103 includes a first field 162, a second field 164, a third field 166, and a fourth field 168. In some examples, the transmitter 102 is configured to transmit the signal 105 according to a transmission scheme that employs power boosting. For example, the transmitter 102 may power-boost one or more portions of the packet 103, and may not power boost one or more other portions of the packet 103. As an example, the transmitter 102 may power boost a preamble (or one or more portions of a preamble) of the packet 103 and may not power boost a data portion of the packet 103. The first field 162 and the third field 166 may correspond to fields of the one more portions of the packet 103 that are power boosted, and the second field 164 and the fourth field 168 may correspond to fields of the one or more portions of the packet 103 that are not power boosted.

To illustrate, in some examples, the transmitter 102 is configured to transmit the signal 105 according to an IEEE 802.11ax specification in which at least a portion of a preamble of the packet 103 is power boosted and at least a portion of a data payload of the packet 103 is not power boosted. In these examples, the packet 103 may be an IEEE 802.11ax compliant packet that includes a power-boosted legacy-short training field (L-STF), a power-boosted legacy-long training field (L-LTF), a power-boosted high efficiency short training field (HE-STF), a power-boosted high efficiency long training field (HE-LTF), a non-power-boosted legacy signal field (L-SIG), a non-power-boosted high efficiency signal field (HE-SIG-A), and a non-power-boosted high efficiency data field (HE-Data). In these examples, the first field 162 may correspond to the L-LTF field, the second field 164 may correspond to the L-SIG field, the third field 166 may correspond to the HE-LTF field, and the fourth field 168 may correspond to the HE-Data field.

Alternatively, the transmitter 102 may be configured to transmit the signal 105 according to a protocol/standard/specification other than the IEEE 802.11ax specification. For example, the transmitter 102 may be configured to transmit the signal 105 according to an IEEE 802.11ac specification in which a portion of a preamble of the packet 103 is power boosted and at least a portion of a data payload of the packet 103 is not power boosted. In these examples, the packet 103 may correspond to an 802.11ac packet that includes a power-boosted legacy-short training field (L-STF), a power-boosted legacy-long training field (L-LTF), a power-boosted very high throughput short training field (VHT-STF), a power-boosted very high throughput long training field (VHT-LTF), a non-power-boosted legacy signal field (L-SIG), a non-power-boosted very high throughput signal field (VHT-SIG-A), and a non-power-boosted data field (Data). In these examples, the first field 162 may correspond to the L-LTF field, the second field 164 may correspond to the L-SIG field, the third field 166 may correspond to the VHT-LTF field, and the fourth field 168 may correspond to the Data field.

The receiver 104 is configured to receive a signal (e.g., a received signal) 107 corresponding to the signal 105. The receiver 104 may include processing circuitry 150 configured to process the signal 107. For example, the system 100 may correspond to an OFDM system, and the processing circuitry 150 may downconvert the signal 107 to baseband, may analog-to-digital convert the signal 107, may remove a cyclic prefix from the signal 107, and/or may serial to parallel convert the signal 107 to organize and convert the signal 107 into a parallel signal for further processing. The parallel signal may be provided to transform circuitry 108 (e.g., a fast Fourier transform processor), which may convert the parallel signal into a frequency domain signal 109 (e.g., Y_{i,k}). The frequency domain signal 109 (e.g., including an OFDM symbol) may be corrupted (relative to the signal 105) by the channel 106, which may introduce amplitude and phase distortion to samples from each of the subcarrier frequencies.

The frequency domain signal 109 may be provided to a tone power estimation engine 110 (e.g., tone power estimation circuitry). The tone power estimation engine 110 is configured to determine a first power 112 associated with the first field 162 of the packet 103 and to determine a second power 114 associated with the second field 164 of the packet 103. The first power 112 may correspond to or be based on a first average of tone powers of tones in (or corresponding to) the first field 162 of the packet 103, and the second power 114 may correspond to or be based on a second average of second tone powers of tones in (or corresponding to) the second field 164 of the packet 103. In some implementations, the tone power estimation engine 110 is further configured to determine a third power associated with the third field 166 of the packet 103 and a fourth power associated with the fourth field 168 of the packet 103.

To illustrate, when the packet 103 is an 802.11ax or an 802.11ac compliant packet, the tone power estimation engine 110 may be configured to determine a power for each of the tones in the L-LTF field, and may be configured to determine an average of the powers of the tones of the L-LTF field. In this example, the determined averages of the tone powers of the L-LTF field may correspond to the first power 112. In this example, the tone power estimation engine 110 may be configured to determine a power for each of the tones in the L-SIG field, and may be configured to determine an average of the tone powers of the L-SIG field. In this example, the determined averages of the tone powers of the L-SIG field may correspond to the second power 114. In some implementations, averages of the tone powers of the HE-LTF field (or the VHT-LTF field) and averages of the tone powers of the HE-SIG-A field (or the HE data field, the VHT-SIG-A field, or the Data field) correspond to the third power and the fourth power, respectively.

The receiver 104 is configured to determine a channel estimation adjustment factor 118 (e.g., a power difference) that is used to adjust or scale a first channel estimation 122. The channel estimation adjustment factor 118 (e.g., the power difference) may correspond to a quantified representation of a magnitude or degree by which the first power 112 differs from the second power 114. The receiver 104 may be configured to determine the channel estimation adjustment factor 118 (e.g., to determine the power difference) by determining a ratio of the first power 112 and the second power 114 or by subtracting the second power 114 from the first power 112. For example, the receiver 104 may include a channel estimation adjustment factor determination engine 116 (e.g., channel estimation adjustment factor determination circuitry or power difference estimation circuitry) configured to determine the power difference between the first power 112 and the second power 114. In some examples, the channel estimation adjustment factor determination engine 116 (e.g., the power difference estimation circuitry) is configured to determine the channel estimation adjustment factor 118 (e.g., the power difference) by determining a ratio of the first power 112 and the second power 114. To illustrate, when the packet 103 is an 802.11ax compliant packet or an IEEE 802.11ac compliant packet, the receiver 104 may determine the channel estimation adjustment factor 118 (F) based on Equation 1, where P_{LLTF} corresponds to the average of the tone powers of the L-LTF field and P_{LSIG} corresponds to the average of the tone powers of the L-SIG field.

$$F = \frac{{P}_{LLTF}}{{P}_{LSIG}} \qquad Equation 1$$

In some implementations, the channel estimation adjustment factor determination engine 116 is configured to determine the channel estimation adjustment factor 118 based on two power comparisons. To illustrate, the channel estimation adjustment factor determination engine 116 may determine a first channel estimation adjustment factor based on the first power 112 and based on the second power 114, and the channel estimation adjustment factor determination engine 116 may determine a second channel estimation factor based on the third power and based on the fourth power. For example, the first channel adjustment factor may be based on a ratio of (or a difference between) the first power 112 and the second power 114, and the second channel adjustment factor may be based on a ratio of (or a difference between) the third power and the fourth power. In a particular implementation, the first channel adjustment factor is based on powers of L-LTF and L-SIG fields, and the second channel adjustment factor is based on powers of HE-LTF and HE-SIG-A (or HE-Data) fields. In another particular implementation, the first channel estimation adjustment factor is based on powers of L-LTF and L-SIG fields, and the second channel adjustment factor is based on power of VHT-LTF and VHT-SIG-A (or Data) fields. The channel estimation adjustment factor determination engine 116 may determine the channel estimation adjustment factor 118 based on the first channel estimation adjustment factor and the second channel estimation adjustment factor. In a particular implementation, the channel estimation adjustment factor 118 is an average of the first channel estimation adjustment factor and the second channel estimation adjustment factor.

The channel estimation adjustment factor 118 (e.g., the power difference) may thus represent a quantitative relation between different powers used to transmit different fields of the packet 103. As described in more detail below, the quantitative relation represented by the channel estimation adjustment factor 118 (e.g., the power difference) is used to adjust or scale the first channel estimation 122.

The frequency domain signal 109 Y_{i,k} may be provided to a first channel estimation engine 120 (e.g., first channel estimation circuitry) that is configured to determine the first channel estimation 122. In the OFDM example used above, the first channel estimation 122 (e.g., H_{i,k}^{est}) may correspond to an estimate of the channel impulse response H_{i,k} as in Equation 2, where N_{i,k} corresponds to noise.

Y_{i,k}=X_{i,k}H_{i,k}+N_{i,k} Equation 2

The first channel estimation engine 120 may determine the first channel estimation 122 based on a set of pilot tone locations or on another signal that has predictable characteristics such as known bits and subcarrier locations. For example, when the packet 103 is an 802.11ax compliant packet, the first channel estimation engine 120 may determine the first channel estimation 122 based on the pilot tones in the HE-LTF field of the packet 103. As another example, when the packet 103 is an 802.11ac compliant packet, the first channel estimation engine 120 may determine the first channel estimation 122 based on the VHT-LTF field of the packet 103. In some examples, the first channel estimation engine 120 may employ a least square technique or a minimum mean square error technique to determine the first channel estimation 122.

The receiver 104 may be configured to determine the second channel estimation 126 that represents or is associated with communication of the packet 103 by scaling the first channel estimation 122 based on the channel estimation adjustment factor 118 (e.g., based on the power difference). To illustrate, the receiver 104 may include second channel estimation circuitry 124 that is configured to receive the first channel estimation 122 and the channel estimation adjustment factor 118 (e.g., the power difference), and that is configured to scale the first channel estimation 122 by the channel estimation adjustment factor 118 or by a value based on the channel estimation adjustment factor 118. For example, the first channel estimation 122 may correspond to H_{i,k}^{est}, and the second channel estimation circuitry 124 may divide the first channel estimation 122 by a square root of the channel estimation adjustment factor 118 (e.g., F) to determine the second channel estimation H_{i,k}^{est}^{_}^{scaled} according to Equation 3.

$${H}_{i , k}^{est\_scaled} = \frac{{H}_{i , k}^{est}}{\sqrt{F}} \qquad Equation 3$$

Because the second channel estimation 126 is determined using a channel adjustment factor that is based on a quantitative relation of a power used to transmit a field that is power boosted and a power used to transmit a field that is not power boosted, the second channel estimation 126 may compensate for differences in power between the power boosted and non-power boosted fields, resulting in a more accurate channel estimation when power boosting is used (e.g., as in a IEEE 802.11ax compliant packet using a high-efficiency single-user physical layer convergence procedure (PLCP) protocol data unit (PPDU) format).

The receiver 104 includes an equalizer 128 configured to correct the amplitude and phase distortion of the signal 107 using equalizer coefficients that are determined for each subcarrier using equalizer coefficients W_{i,k} that are based on the second channel estimation 126. For example, the equalizer coefficients may be a function of the second channel estimation 126 as in Equation 4.

$${W}_{i , k} = \frac{1}{{H}_{i , k}^{est\_scaled}} \qquad Equation 4$$

In some examples, the equalizer 128 is configured to determine an estimated equalized signal 111 using the equalizer coefficients determined based on the second channel estimation 126. For example, the equalizer 128 may determine the estimated equalized signal 111X according to Equation 5, where X_{i,k}^{est} corresponds to the estimated equalized signal 111, Y_{i,k} corresponds to the frequency domain signal 109, and W_{i,k} corresponds to equalizer coefficients.

X_{i,k}^{est}=Y_{i,k}×W_{i,k} Equation 5

In some examples, as described above, the signal 105 may include a power boosted portion and a non-power boosted portion. For example, the non-power boosted portion may include a quadrature amplitude modulation (QAM) modulated data field (e.g., the fourth field 168).

The receiver 104 may include a QAM demapper 130 that maps the estimated equalized signal 111 to QAM constellation points to determine bit values of the packet 103. Because the equalized signal 111 is determined using an adjustment factor that compensates for different transmit powers used for different fields of the packet 103, the QAM demapper 130 may provide more accurate bit values than demappers that demap an equalized signal 111 based on a first channel estimation that does not compensate for the different transmit powers.

The receiver 104 may additionally include a classification engine 172 (e.g., classification circuitry) configured to classify the packet 103 as a power-boosted packet or a non-power boosted packet. In some examples, the classification engine 172 is configured to classify the packet 103 based on whether the channel estimation adjustment factor 118 (e.g., the power difference between the first power 112 and the second power 114) satisfies a threshold 174. For example, the threshold 174 may correspond to 2 decibels (dB) and the classification engine 172 may classify the packet 103 as a power-boosted packet when the channel estimation adjustment factor 118 is equal to or greater than 2 dB. Using the classification engine 172 to classify the packet 103 as power boosted or not power boosted may enable the receiver 104 to determine whether the packet 103 is power boosted sooner than receivers that determine whether the packet 103 is power boosted based on a field that is subsequent to the second field 164.

The receiver 104 may include a binary phase shift keying (BPSK) decoder 182 that is configured to process one or more fields of the packet 103 using a first mode when the classification engine 172 classifies the packet 103 as a power-boosted packet, and that is configured to process the one or more fields of the packet 103 using a second mode when the classification engine 172 classifies the packet 103 as a non-power-boosted packet.

For example, when the packet 103 is an IEEE 802.11ax compliant packet, the BPSK decoder 182 may process the HE-SIG-A field using the first mode when the packet 103 is classified as power boosted, and may process the HE-SIG-A field using the second mode when the packet 103 is classified as non-power boosted. The receiver 104 may be able to determine whether the packet 103 is power boosted or not power boosted before processing the HE-SIG-A field, enabling the receiver 104 (e.g., the BPSK decoder 182) to more reliably process the HE-SIG-A field as compared to receivers that do not determine whether the packet 103 is power boosted prior to processing the HE-SIG-A field.

As another example, as described above, the packet 103 may be compliant with an IEEE specification other than the IEEE 802.11ax specification, such as the IEEE 802.11a specification, the IEEE 802.11g specification, the IEEE 802.11n specification, or the IEEE 802.11ac specification. To illustrate, when the packet 103 is an IEEE 802.11ac compliant packet, the BPSK decoder 182 may process any one or more of the VHT-SIG-A fields of the packet 103 using the first mode when the packet 103 is classified as power boosted. In these examples, the BPSK decoder 182 may process the VHT-SIG-A fields of the packet 103 using the second mode when the packet 103 is classified as non-power boosted. The receiver 104 may be able to determine whether the packet 103 is power boosted or not power boosted before processing the VHT-SIG-A field, enabling the receiver 104 (e.g., the BPSK decoder 182) to more reliably process the VHT-SIG-A field as compared to receivers that do not determine whether the packet 103 is power boosted prior to processing the VHT-SIG-A field.

In some implementations, the packet 103 is transmitted using higher orders of QAM modulation than are typically used. To illustrate, higher orders of QAM modulation are typically harder to decode at a receiver. However, because the receiver 104 is able to decode signals based on a channel estimate that is scaled based on powers of particular fields, the packet 103 may be modulated according to 16-QAM, 32-QAM, 64-QAM, 128-QAM, or 256-QAM techniques.

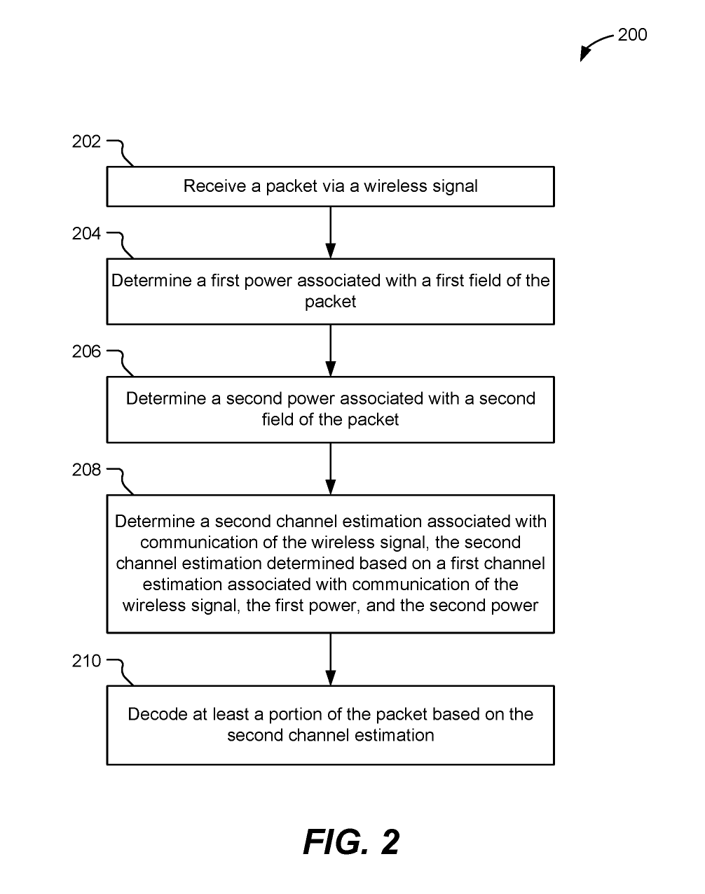

Referring to FIG. 2, a flow chart of an illustrative example of a method 200 of determining a channel estimation is depicted. The method 200 may be performed by the receiver 104 of FIG. 1.

The method 200 includes, at 202, receiving a packet via a wireless signal. For example, the packet may correspond to the packet 103 described above with reference to FIG. 1 and the wireless signal may correspond to the signal 105 described above with reference to FIG. 1. In some implementations, the packet is an IEEE 802.11ax compliant packet. In other implementations, the packet is compliant with a specification other than the IEEE 802.11ax specification. For example, the packet may be compliant with the IEEE 802.11a specification, the IEEE 802.11g specification, the IEEE 802.11n specification, or the IEEE 802.11ac specification.

The method 200 includes, at 204, determining a first power associated with a first field of the packet. For example, the first field may correspond to the first field 162 described above with reference to FIG. 1, and the first power may be determined as described above with reference to the first power 112 of FIG. 1. In some implementations, the first field is power-boosted by a transmitter of the wireless signal. In some implementations, the first field corresponds to a legacy long training field (e.g., a L-LTF).

The method 200 includes, at 206, determining a second power associated with a second field of a packet. For example, the second field may correspond to the second field 164 described above with reference to FIG. 1, and the second power may be determined as described above with reference to the second power 114 of FIG. 1. In some implementations, the second field is not power boosted by the transmitter of the wireless signal. In some implementations, the second field corresponds to a legacy signal field (e.g., a L-SIG field).

The method 200 includes, at 208, determining a second channel estimation associated with communication of the wireless signal. The second channel estimation is determined based on the first power, the second power, and a first channel estimation associated with communication of the wireless signal. For example, the second channel estimation may correspond to the second channel estimation 126 described above with reference to FIG. 1, the channel may correspond to the channel 106 of FIG. 1, and the first channel estimation may correspond to the first channel estimation 122 of FIG. 1. In some implementations, the method 200 further includes determining a channel estimation adjustment factor based on the first power and the second power as described above with reference to FIG. 1. In some implementations, determining the channel estimation adjustment factor includes determining a ratio of the first power and the second power as described above with reference to Equation 1.

Because the second channel estimation is determined using a channel adjustment factor that is based on a quantitative relation of a power used to transmit a field that is power boosted and a power used to transmit a field that is not power boosted, the second channel estimation 126 may compensate for differences in power between the power boosted and non-power boosted fields, resulting in a more accurate channel estimation when power boosting is used (e.g., as in a IEEE 802.11ax high efficiency single user PPDU format).

The method 200 further includes, at 210, decoding at least a portion of the packet based on the second channel estimation. In some examples, the at least the portion of the packet corresponds to the fourth field 168 of FIG. 1. In some implementations, decoding the at least the portion of the packet includes determining equalization coefficients based on the second channel estimation. For example, the equalization coefficients may be determined as described above with reference to Equation 4. In some of these implementations, the method 200 further includes equalizing a data field of the packet using the determined equalization coefficients. For example, when the packet is an IEEE 802.11ax compliant packet, the data field may correspond to the HE-Data field described above with reference to FIG. 1, and the HE-Data field may be equalized according to Equation 5. Alternatively or additionally, when the packet is an IEEE 802.11ac compliant packet, the data field may correspond to the Data field described above with reference to FIG. 1, and the Data field may be equalized according to Equation 5. In some implementations, decoding the at least the portion of the packet includes demapping the at least the portion of the packet. For example, the fourth field 168 may be demapped by the QAM demapper 130 described above with reference to FIG. 1. Because the data of the data field is equalized using a channel estimation (e.g., the second channel estimation) that compensates for different transmit powers used for different fields of the packet 103, the equalized data field may more accurately represent the mapped constellation points of the transmitted data (e.g., X_{i,k} described above with reference to FIG. 1) than data that is equalized using a channel estimation that does not compensate for the different transmit powers (e.g., data that is equalized using the first channel estimation 122).

In some implementations, the method 200 further includes classifying the packet as a power-boosted packet based on a ratio of the first power to the second power. For example, the classification engine 172 described above with reference to FIG. 1 may classify the packet as a power-boosted packet when the ratio satisfies a threshold. Classifying the packet 103 as power boosted or not power boosted based on the ratio of the first power to the second power does not require knowledge of data in fields of the packet that are subsequent to the second field. Thus, classifying the packet 103 as power boosted or not power boosted on the ratio of the first power to the second power may enable the receiver 104 to determine whether the packet 103 is power boosted sooner than receivers that determine whether the packet 103 is power boosted based on a field that is subsequent to the second field 164.

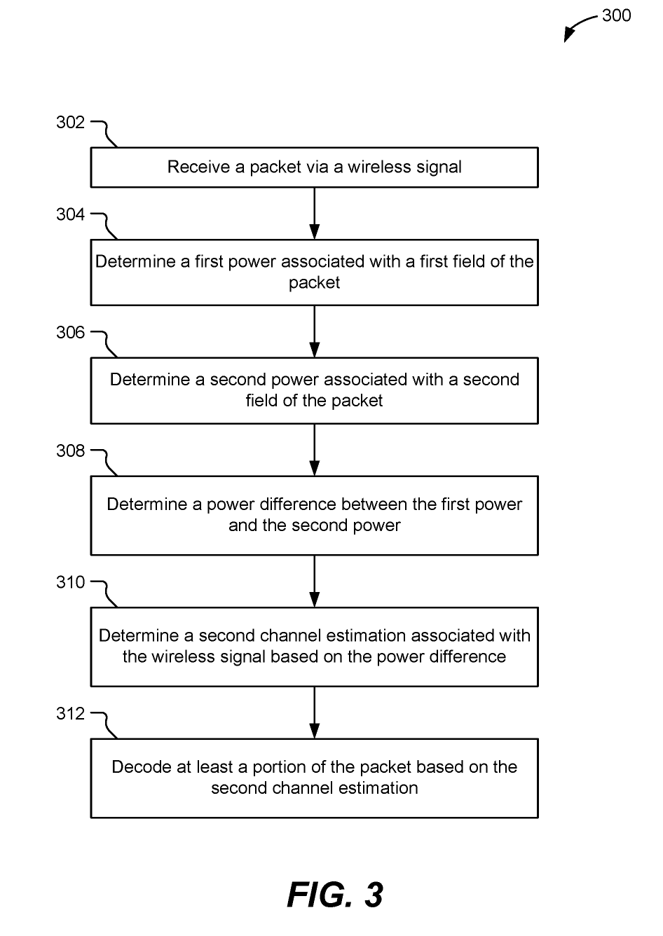

Referring to FIG. 3, a flow chart of an illustrative example of a method 300 of determining a channel estimation is depicted. The method 300 may be performed by the receiver 104 of FIG. 1.

The method 300 includes, at 302, receiving a packet via a wireless signal. For example, the packet may correspond to the packet 103 described above with reference to FIG. 1 and the wireless signal may correspond to the signal 105 described above with reference to FIG. 1. In some implementations, the packet is an IEEE 802.11ax compliant packet. In other implementations, the packet is compliant with a specification other than the IEEE 802.11ax specification. For example, the packet may be compliant with the IEEE 802.11a specification, the IEEE 802.11g specification, the IEEE 802.11n specification, or the IEEE 802.11ac specification.

The method 300 includes, at 304, determining a first power associated with a first field of the packet. For example, the first field may correspond to the first field 162 described above with reference to FIG. 1, and the first power may be determined as described above with reference to the first power 112 of FIG. 1. In some implementations, the first field is power-boosted by a transmitter of the wireless signal. In some implementations, the first field corresponds to a legacy long training field (e.g., a L-LTF) or a legacy short training field (e.g., a L-STF).

The method 300 includes, at 306, determining a second power associated with a second field of a packet. For example, the second field may correspond to the second field 164 described above with reference to FIG. 1, and the second power may be determined as described above with reference to the second power 114 of FIG. 1. In some implementations, the second field is not power boosted by the transmitter of the wireless signal. In some implementations, the second field corresponds to a legacy signal field (e.g., a L-SIG field).

The method 300 includes, at 308, determining a power difference between the first power and the second power. For example, the power difference may correspond to a representation of a magnitude or degree by which the first power differs from the second power. For example, the power difference may correspond to a result of subtracting the second power from the first power. In this example, determining the power difference includes subtracting the second power from the first power. Alternatively, the power difference may correspond to a ratio of the first power and the second power. In this example, determining the power difference includes dividing the first power by the second power as in Equation 1 above. The power difference may be estimated using the power difference estimation circuitry described above with reference to FIG. 1.

The method 300 includes, at 310, determining a second channel estimation associated with the wireless signal based on the power difference. For example, the second channel estimation may correspond to the second channel estimation 126 described above with reference to FIG. 1. As an example, determining the second channel estimation associated with the wireless signal may include scaling a first channel estimation associated with the wireless signal based on the power difference. The first channel estimation may correspond to the first channel estimation 122 described above with reference to FIG. 1.

Because the second channel estimation is determined using the power difference that is based on a quantitative relation of a power used to transmit a field that is power boosted and a power used to transmit a field that is not power boosted, the second channel estimation 126 may compensate for differences in power between the power boosted and non-power boosted fields, resulting in a more accurate channel estimation when power boosting is used (e.g., as in a IEEE 802.11ax high efficiency single user PPDU format).

The method 300 further includes, at 312, decoding at least a portion of the packet based on the second channel estimation. In some examples, the at least the portion of the packet corresponds to the fourth field 168 of FIG. 1. In some implementations, decoding the at least the portion of the packet includes determining equalization coefficients based on the second channel estimation. For example, the equalization coefficients may be determined as described above with reference to Equation 4. In some of these implementations, the method 300 further includes equalizing a data field of the packet using the determined equalization coefficients. For example, when the packet is an IEEE 802.11ax compliant packet, the data field may correspond to the HE-Data field described above with reference to FIG. 1, and the HE-Data field may be equalized according to Equation 5. Alternatively or additionally, when the packet is an IEEE 802.11ac compliant packet, the data field may correspond to the Data field described above with reference to FIG. 1, and the Data field may be equalized according to Equation 5. In some implementations, decoding the at least the portion of the packet includes demapping the at least the portion of the packet. For example, the fourth field 168 may be demapped by the QAM demapper 130 described above with reference to FIG. 1. Because the data of the data field is equalized using a channel estimation (e.g., the second channel estimation) that compensates for different transmit powers used for different fields of the packet 103, the equalized data field may more accurately represent the mapped constellation points of the transmitted data (e.g., X_{i,k} described above with reference to FIG. 1) than data that is equalized using a channel estimation that does not compensate for the different transmit powers (e.g., data that is equalized using the first channel estimation 122).

In some implementations, the method 300 further includes classifying the packet as a power-boosted packet based on the power difference. For example, the classification engine 172 described above with reference to FIG. 1 may classify the packet as a power-boosted packet when the power difference satisfies a threshold. Classifying the packet 103 as power boosted or not power boosted based on the power difference of the first power and the second power does not require knowledge of data in fields of the packet that are subsequent to the second field. Thus, classifying the packet 103 as power boosted or not power boosted on the power difference of the first power to the second power may enable the receiver 104 to determine whether the packet 103 is power boosted sooner than receivers that determine whether the packet 103 is power boosted based on a field that is subsequent to the second field 164.

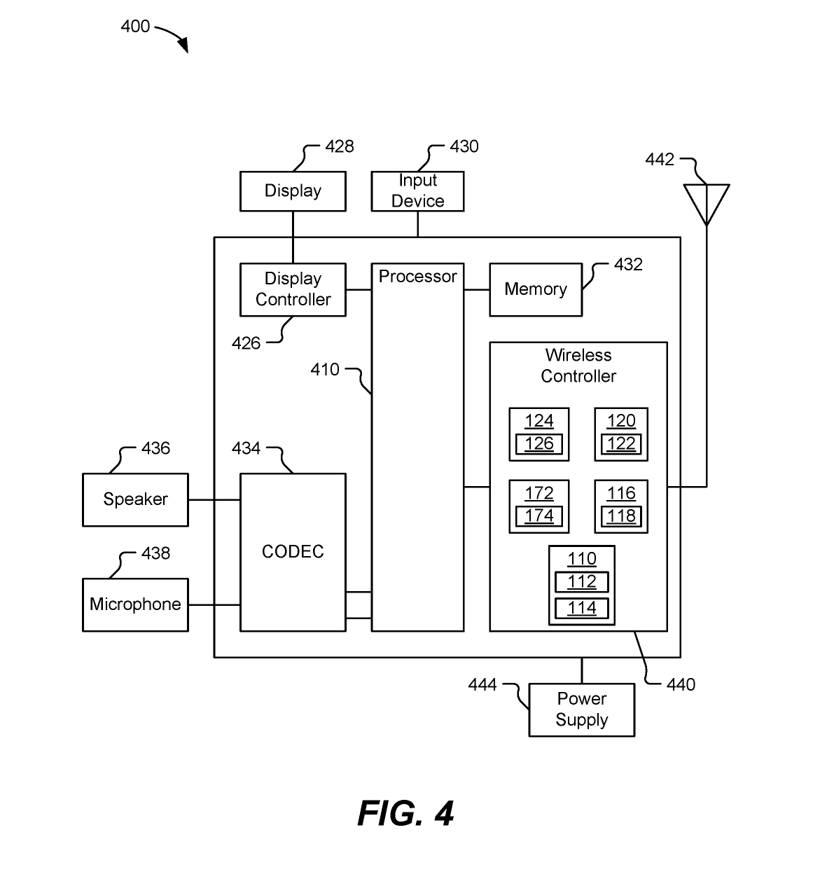

Referring to FIG. 4, a block diagram of a particular illustrative example of a wireless communication device is depicted and generally designated 400. The wireless communication device 400 includes a processor 410, such as a digital signal processor (DSP), coupled to a memory 432 (e.g., a random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art). In some implementations, the memory 432 includes or corresponds to a non-transitory, computer readable medium storing instructions that, when executed by the processor 410, cause the processor 410 to perform operations described herein.

FIG. 4 also shows a display controller 426 that is coupled to the processor 410 and to a display 428. A coder/decoder (CODEC) 434 may also be coupled to the processor 410. A speaker 436 and a microphone 438 may be coupled to the CODEC 434.

FIG. 4 also indicates that a wireless controller 440 may be coupled to the processor 410 and may be further coupled to an antenna 442. The wireless controller 440 may include one or more ICs, such as RF IC components (e.g., switches). The wireless controller 440 may include the tone power estimation engine 110 of FIG. 1 to determine the first power 112 and the second power 114 as described above with reference to FIG. 1. The wireless controller 440 additionally includes the channel estimation adjustment factor determination engine 116 of FIG. 1 to determine a channel estimation adjustment factor 118 as described above with reference to FIG. 1. The wireless controller 440 additionally includes the first channel estimation engine 120 of FIG. 1 to determine a first channel estimation 122 as described above with reference to FIG. 1. The wireless controller 440 additionally includes the second channel estimation circuitry 124 of FIG. 1 to determine the second channel estimation 126 as described above with reference to FIG. 1. The wireless controller 440 additionally includes the classification engine 172 of FIG. 1 to classify a received packet as power-boosted as described above with reference to FIG. 1.

In a particular implementation, the processor 410, the display controller 426, the memory 432, the CODEC 434, and the wireless controller 440 are included in a system-in-package or system-on-chip device 422. In a particular implementation, an input device 430 and a power supply 444 are coupled to the system-on-chip device 422. Moreover, in a particular example, as illustrated in FIG. 4, the display 428, the input device 430, the speaker 436, the microphone 438, the antenna 442, and the power supply 444 are external to the system-on-chip device 422. However, each of the display 428, the input device 430, the speaker 436, the microphone 438, the antenna 442, and the power supply 444 may be coupled to a component of the system-on-chip device 422, such as an interface or a controller.

In conjunction with the described embodiments, an apparatus is disclosed that includes means for receiving a packet via a wireless signal. For example, the means for receiving may include or correspond to the receiver 104 of FIG. 1, the antenna 442, the wireless controller 440 of FIG. 4, one or more other structures or circuits configured to receive the packet via the wireless signal, or any combination thereof.

The apparatus includes means for estimating a first power associated with a first field of the packet and a second power associated with a second field of the packet. The means for estimating may include or correspond to the tone power estimation engine 110 of FIG. 1, the tone power estimation engine 110 of FIG. 4, one or more other structures or circuits configured to estimate the first power and the second power, or any combination thereof. The first power may correspond to or be based on a first average of tone powers of tones in a first field of the packet, and the second power may correspond to or be based on a second average of second tone powers of tones of a second field of the packet, as described above with reference to the first power 112 and the second power 114 of FIG. 1. In some implementations, the first field is power boosted and the second field is not power boosted as described above with reference to FIG. 1. In some implementations, the packet is transmitted according to an IEEE 802.11ax specification. In some implementations, the first field corresponds to a legacy long training field (L-LTF) and the second field corresponds to a legacy signal (L-SIG) field.

The apparatus further includes means for determining a second channel estimation of a channel associated with communication of the packet. The second channel estimation is determined based on a first channel estimation of the channel, the first power, and the second power. For example, the means for determining the second channel estimation may include or correspond to the second channel estimation circuitry 124 of FIG. 1, the second channel estimation circuitry 124 of FIG. 4, one or more other structures or circuits configured to determine the second channel estimation, or any combination thereof. The first channel estimation of the channel may be determined based on pilot tones associated with a third field of the packet, as described above with reference to FIG. 1.

In some implementations, the apparatus further includes comprising means for determining a channel estimation adjustment factor based on the first power and the second power. For example, the means for determining the channel estimation adjustment factor may include or correspond to the channel estimation adjustment factor determination engine 116 of FIG. 1, the channel estimation adjustment factor determination engine 116 of FIG. 4, one or more other structures or circuits configured to determine the channel estimation adjustment factor, or any combination thereof. In these examples, the means for determining the second channel estimation is configured to determine the second channel estimation by scaling the first channel estimation based on the channel estimation adjustment factor. In some implementations, determining the channel estimation adjustment factor includes determining a ratio of the first power to the second power as described above with reference to Equation 1.

In some implementations, the apparatus further includes means for equalizing a data field of the packet using equalizing coefficients determined based on the second channel estimation. For example, the means for equalizing may include or correspond to the equalizer 128 of FIG. 1, one or more structures or circuits configured to equalize the data field, or any combination thereof. The equalizing coefficients may be determined as described above with reference to Equation 4.

In some implementations, the apparatus further includes means for classifying the packet as a power-boosted packet based on a ratio of the first field to the second field. For example, the means for classifying may include or correspond to the classification engine 172 of FIG. 1, the classification engine 172 of FIG. 4, one or more other structures or circuits configured to classify the packet, or any combination thereof. In some of these implementations, the means for classifying is configured to classify the packet as a power-boosted packet when the ratio satisfies a threshold as described above with reference to the threshold 174 of FIG. 1.

Although one or more of FIGS. 1-4 may illustrate systems, devices, and/or methods according to the teachings of the disclosure, the disclosure is not limited to these illustrated systems, devices, and/or methods. Aspects, examples, and/or implementations of the disclosure may be suitably employed in any device that includes integrated circuitry including memory, a processor, and on-chip circuitry.

One or more functions or components of any of FIGS. 1-4 as illustrated or described herein may be combined with one or more other portions of another of FIGS. 1-4. Accordingly, no single aspect, example, and/or implementation described herein should be construed as limiting and aspects, examples, and/or implementations of the disclosure may be suitably combined without departing form the teachings of the disclosure.

Those of skill would further appreciate that the various illustrative logical blocks, configurations, modules, circuits, and algorithm steps described in connection with the aspects, examples, and/or implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects, examples, and/or implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal. A storage device is not a signal.

The previous description of the disclosed aspects, examples, and/or implementations is provided to enable a person skilled in the art to make or use the disclosed aspects, examples, and/or implementations. Various modifications to these aspects, examples, and/or implementations will be readily apparent to those skilled in the art, and the principles defined herein may be applied to other aspects, examples, and/or implementations without departing from the scope of the disclosure. Thus, the present disclosure is not intended to be limited to the aspects, examples, and/or implementations shown herein but is to be accorded the widest scope possible consistent with the principles and novel features as defined by the following claims.

What is claimed is:

1. A receiver, comprising:
power estimation circuitry configured to estimate a first power associated with a first field of a packet and a second power associated with a second field of the packet; and
channel estimation circuitry configured to determine a second channel estimation of a channel associated with communication of the packet, the second channel estimation determined based on the first power, the second power, and a first channel estimation of the channel.

2. The receiver of claim 1, further comprising channel estimation adjustment factor determination circuitry configured to determine a channel estimation adjustment factor based on the first power and the second power, wherein the channel estimation circuitry is configured to determine the second channel estimation by scaling the first channel estimation based on the channel estimation adjustment factor.

3. The receiver of claim 2, wherein the channel estimation adjustment factor determination circuitry is configured to determine the channel estimation adjustment factor by determining a ratio of the first power and the second power.

4. The receiver of claim 1, wherein the first field is power boosted by a transmitter of the packet and the second field is not power boosted by the transmitter.

5. The receiver of claim 1, further comprising processing circuitry configured to determine equalization coefficients based on the second channel estimation.

6. The receiver of claim 5, wherein the processing circuitry is configured to equalize a data field of the packet using the equalization coefficients.

7. The receiver of claim 1, wherein the packet is an Institute of Electrical and Electronics Engineers (IEEE) 802.11ax compliant packet.

8. The receiver of claim 1, wherein the first field corresponds to a legacy long training field (L-LTF).

9. The receiver of claim 8, wherein the second field corresponds to a legacy signal (L-SIG) field.

10. The receiver of claim 1, wherein the first field corresponds to a high efficiency long training field (HE-LTF).

11. The receiver of claim 10, wherein the second field corresponds to a high efficiency signal (HE-SIG-A) field.

12. The receiver of claim 1, wherein the packet is an Institute of Electrical and Electronics Engineers (IEEE) 802.11ac compliant packet.

13. The receiver of claim 1, wherein the first field corresponds to a very high throughput long training field (VHT-LTF).

14. The receiver of claim 13, wherein the second field corresponds to a very high throughput signal (VHT-SIG-A) field.

15. The receiver of claim 1, further comprising classification circuitry configured to classify the packet as a power-boosted packet based on a ratio of the first power and the second power.

16. The receiver of claim 15, wherein the classification circuitry is configured to classify the packet as the power-boosted packet based on the ratio satisfying a threshold.

17. A method, comprising:
receiving a packet via a wireless signal;
determining a first power associated with a first field of a packet;
determining a second power associated with a second field of the packet;
determining a second channel estimation associated with communication of the wireless signal, the second channel estimation determined based on the first power, the second power, and a first channel estimation associated with communication of the wireless signal; and
decoding at least a portion of the packet based on the second channel estimation.

18. The method of claim 17, further comprising determining a channel estimation adjustment factor based on the first power and the second power, wherein determining the second channel estimation includes scaling the first channel estimation based on the channel estimation adjustment factor.

19. The method of claim 18, wherein the channel estimation adjustment factor is determined based on a difference between the first power and the second power.

20. The method of claim 17, wherein the first field is power boosted by a transmitter of the wireless signal and the second field is not power boosted by the transmitter.

21. The method of claim 17, wherein decoding the at least the portion of the packet based on the second channel estimation includes:
determining equalization coefficients based on the second channel estimation; and
equalizing a data field of the packet using the equalization coefficients.

22. The method of claim 17, wherein the first field corresponds to a legacy long training field (L-LTF) or a legacy short training field (L-STF), and wherein the second field corresponds to a legacy signal (L-SIG) field.

23. The method of claim 17, wherein the first field corresponds to a high efficiency long training field (HE-LTF) or a high efficiency short training field (HE-STF), and wherein the second field corresponds to a high efficiency signal (HE-SIG-A) field.

24. The method of claim 17, wherein the first field corresponds to a very high throughput long training field (VHT-LTF) or a very high throughput short training field (VHT-STF), and wherein the second field corresponds to a very high throughput signal (VHT-SIG-A) field.

25. The method of claim 17, further comprising:
classifying the packet as a power-boosted packet or a non-power-boosted packet based on a ratio of the first power to the second power; and
processing at least a third field of the packet using a first mode based on the packet being classified as the power-boosted packet, the third field subsequent to the second field in the packet.

26. The method of claim 25, further comprising processing at least the third field using a second mode based on the packet being classified as the non-power-boosted packet.

27. An apparatus, comprising:
means for receiving a packet via a wireless signal;
means for estimating a first power associated with a first field of the packet and a second power associated with a second field of the packet; and
means for determining a second channel estimation of a channel associated with communication of the packet, the second channel estimation determined based on the first power, the second power, and a first channel estimation of the channel.

28. The apparatus of claim 27, further comprising means for determining a channel estimation adjustment factor based on the first power and the second power, wherein the means for determining the second channel estimation is further configured to determine the second channel estimation by scaling the first channel estimation based on the channel estimation adjustment factor.

29. A non-transitory, computer readable medium storing instructions that, when executed by a processor, cause the processor to:
receive a packet via a wireless signal;
determine a first power associated with a first field of the packet;
determine a second power associated with a second field of the packet;
determine a second channel estimation associated with communication of the wireless signal, the second channel estimation determined based on the first power, the second power, and a first channel estimation associated with communication of the wireless signal; and
decode at least a portion of the packet based on the second channel estimation.

30. The non-transitory, computer readable medium of claim 29, wherein the first field is power boosted by a transmitter of the packet and the second field is not power boosted by the transmitter.
